(19) United States
(12) Patent Application Publication
(10) Pub. No.: US 2014/0183305 A1
(43) Pub. Date: Jul. 3, 2014

(54) BRACKET FOR MOUNTING CABLES

(71) Applicant: HON HAI PRECISION INDUSTRY CO., LTD., New Taipei (TW)

(72) Inventor: YUN-LUNG CHEN, New Taipei (TW)

(73) Assignee: HON HAI PRECISION INDUSTRY CO., LTD., New Taipei (TW)

(21) Appl. No.: 14/043,960

(22) Filed: Oct. 2, 2013

(30) Foreign Application Priority Data
Dec. 27, 2012 (CN) 2012105774762

(51) Int. Cl. H02G 1/00

(52) U.S. Cl. CPC H02G 1/00
USPC 248/65; 248/304

(57) ABSTRACT

A bracket includes a side plate and a retaining member. The retaining member is located on the side plate. A receiving space is defined in the retaining member for receiving a cable. The retaining member includes a bent portion and a retaining portion. The bend portion is substantially parallel to the side plate. The retaining portion is located at an end of the bent portion.

### BACKGROUND

1. Technical Field

The disclosure generally relates to brackets within an electronic device, and especially to a bracket for mounting cables.

2. Description of Related Art

A number of cables is used in an electronic device for transmitting power signals or digital signals. Whether the cables are left unorganized in the electronic device or tied by flexible cable ties, the cables occupy a lot of space in the electronic device. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a bracket and a cable in one embodiment.

FIG. 2 is an assembled view of the bracket and the cable of FIG. 1.

FIG. 3 is a bottom view of the bracket and the cable of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

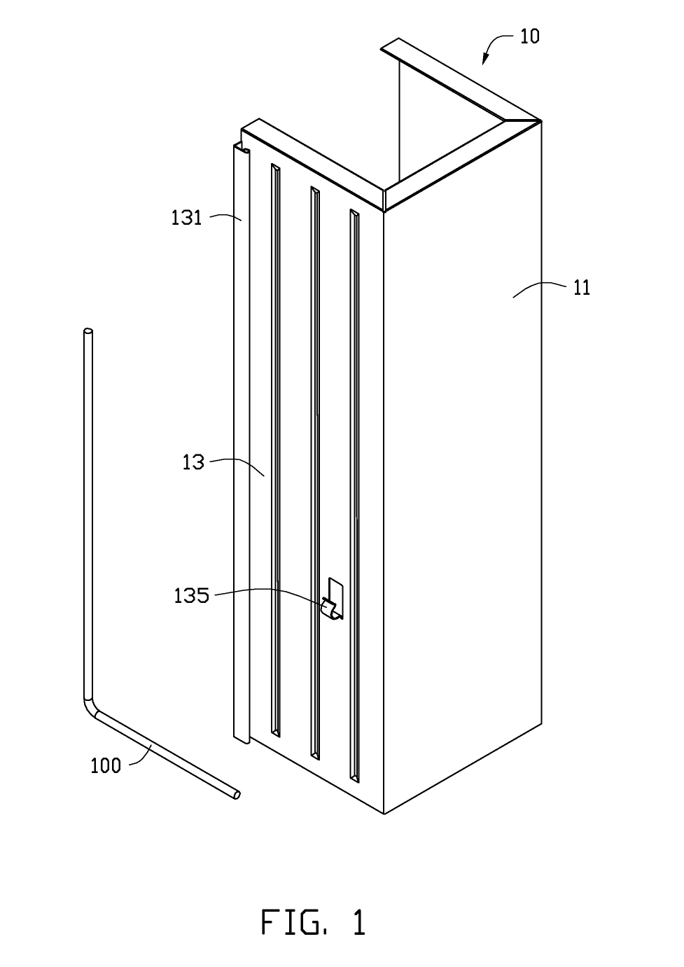

FIG. 1 is an isometric view of a bracket 10 and a cable 100. The bracket 10 can retain the cable 100. The bracket 10 can be located in an electronic device, such as a computer, or a vending machine, for example.

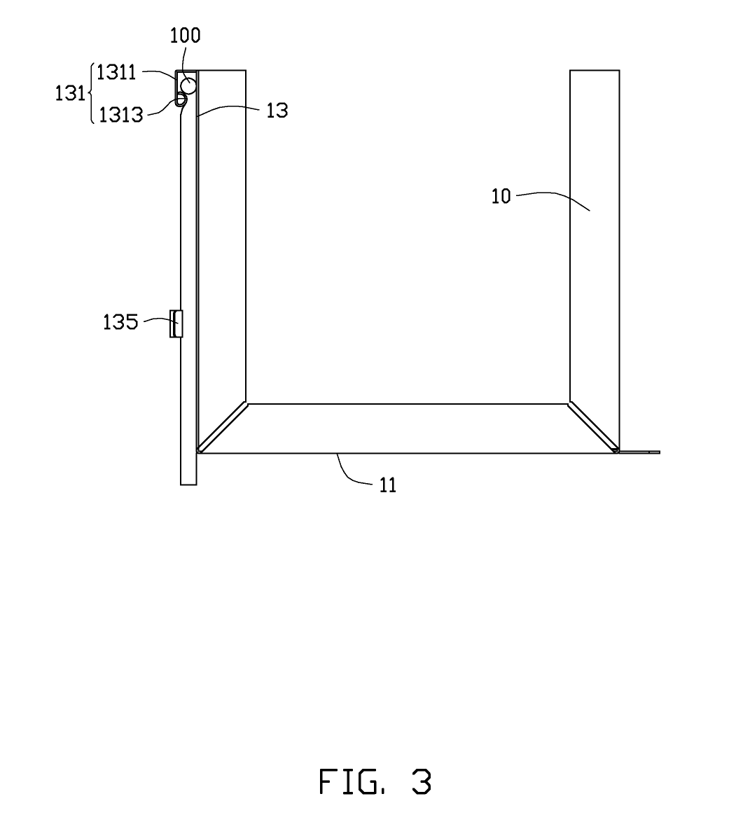

FIG. 3 illustrates a bottom view of an assembled bracket 10 having the cable 100. The bracket 10 includes a rear plate 11, two side plates 13, and a retaining member 131 located on one of the two side plates 13.

The two side plates 13 are substantially parallel to each other, and are substantially perpendicular to the rear plate 11. A cross section of the bracket 10 is substantially U-shaped. Each side plate 13 is made of metal. A thickness of each side plate 13 is about 0.7 millimeters (mm). A hook 135 is located on one of the two side plates 13 to retain the cable 100 in the retaining member 131.

The retaining member 131 extends from a lateral edge of the side plate 13. The retaining member 131 includes a bend portion 1311 and a retaining portion 1313. The bend portion 1311 is substantially sheet-like. A cross-section of the bend portion 1311 is substantially L-shaped. The retaining portion 1313 is located at an end of the bend portion 1311. The retaining portion 1313 is located on an inner side of the bend portion 1311 adjacent to the side plate 13. A distance between the retaining portion 1313 and the side plate 13 is smaller than a width of the cable 100. A receiving space is defined between the retaining member 131 and the side plate 13 to retain the cable 100. The retaining portion 1313 is bent from a substantially sheet-like piece. A cross-section of the retaining portion 1313 is substantially D-shaped. The bend portion 1311 and the retaining portion 1313 are oriented along a direction that is substantially parallel to the side plate 13.

The bend portion 1311 and the retaining portion 1313 are made of metal. Depending on the embodiment, the bend portion 1311, the retaining portion 1313, or both the bend portion 1311 and the retaining portion 1313 are resilient. When only the bend portion 1311 is resilient, the bend portion 1311 deforms outward to retain the cable 100. When only the retaining portion 1313 is resilient, the retaining portion 1313 deforms toward the bend portion 1311 to retain the cable 100. In other embodiments, neither the bend portion 1311 nor the retaining portion 1313 is resilient, so the cable 100 is resilient to get into the receiving space of the retaining member 131.

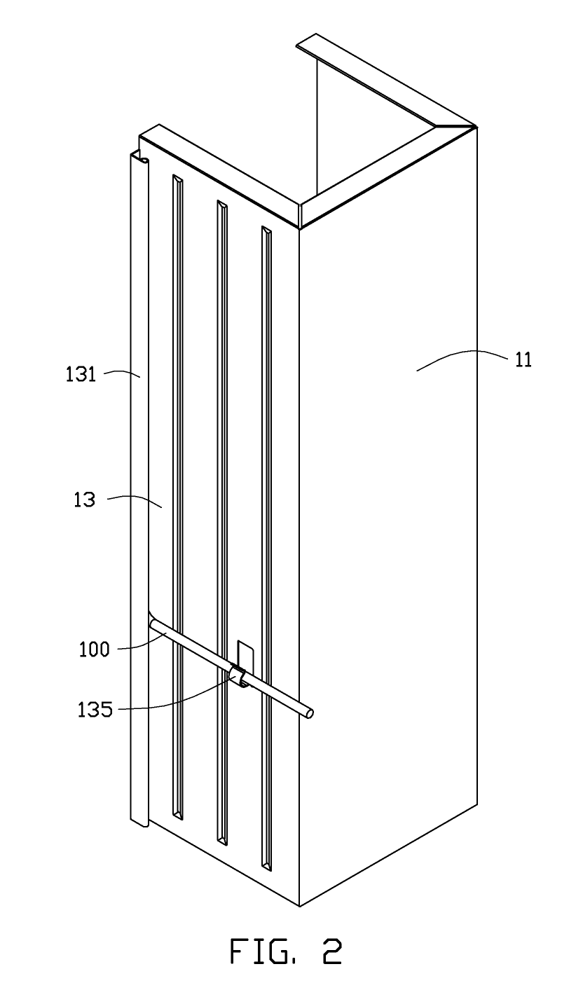

FIG. 2 illustrates an assembled view of the bracket 10 and the cable 100. In use, a first portion of the cable 100 is pushed into and retained in the receiving space of the retaining member 131. A second portion of the cable 100 is retained by the hook 135. The hook 135 retains the cable 100 along a direction that is substantially perpendicular to the orientation direction of the retaining member 131.

The cable 100 is retained in the retaining member 131 along a lateral edge of the side plate 13, so that the cable 100 does not tangle with electronic components located between the two side plates 13.

As disclosed, the retaining member 131 is integral with the bracket 10, thereby eliminating a need for cable ties. The integral retaining member 131 enhances the strength of the bracket 10. The thickness of the bracket 10 is reduced from about 1 mm to about 0.7 mm, thereby reducing a material cost of production.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A bracket, comprising:
a side plate; and
a retaining member located on the side plate, a receiving space defined between the retaining member , the retaining member comprises a bend portion and a retaining portion, the bend portion is substantially parallel to the side plate, and the retaining portion is located at an end of the bend portion.

2. The bracket of claim 1, wherein the bend portion is formed from a piece of sheet, and a cross section of the bend portion is substantially L-shaped.

3. The bracket of claim 1, wherein the bend portion and the retaining portion are configured to be resiliently deformed..

4. The bracket of claim 1, wherein a cross section of the retaining portion is substantially D-shaped.

5. The bracket of claim 1, wherein the retaining member is located at a lateral edge of the side plate.

6. The bracket of claim 1, wherein the bracket further comprising a rear plate, the rear plate is substantially perpendicular to the side plate, and the rear plate and the retaining member are located on opposite sides of the side plate.

7. The bracket of claim 1, wherein the side plate is made of metal, and a thickness of the side plate is substantially 0.7 millimeter.

8. The bracket of claim 1, wherein the retaining portion located on an inner side of the bend portion toward the side plate.

9. The bracket of claim 1, wherein a hook is located on the side plate, the hook retains a cable along a direction which is substantially perpendicular to a travelling direction of the retaining member.

10. A bracket, comprising:
a side plate; and
a retaining member extending from the side plate, a receiving space defined between the retaining member, the retaining member comprising a bend portion and a retaining portion, the bend portion is substantially parallel to the side plate, and the retaining portion is located at an end of the bend portion, and the retaining portion is located on an inner side of the bend portion toward the side plate.

11. The bracket of claim 10, wherein the bend portion is formed from a piece of sheet, and a cross section of the bend portion is substantially L-shaped.

12. The bracket of claim 10, wherein the bend portion and the retaining portion are configured to be resiliently deformed.

13. The bracket of claim 10, wherein a cross section of the retaining portion is substantially D-shaped.

14. The bracket of claim 10, wherein the retaining member is located at an lateral edge of the side plate.

15. The bracket of claim 10, wherein the bracket further comprising a rear plate, the rear plate is substantially perpendicular to the side plate, and the rear plate and the retaining member are located on opposite sides of the side plate.

16. The bracket of claim 10, wherein the side plate is made of metal, and a thickness of the side plate is substantially 0.7 millimeter.

17. The bracket of claim 10, wherein a distance between the retaining portion and the side plate is smaller than a width of the cable.

18. The bracket of claim 10, wherein a hook is located on the side plate, the hook retains the cable along a direction which is substantially perpendicular to a travelling direction of the retaining member.
